(19) United States
(12) Patent Application Publication
(10) Pub. No.: US 2023/0145000 A1
(43) Pub. Date: May 11, 2023

(54) MONITORING DEVICE, COMMUNICATION SYSTEM, COMMUNICATION CONTROL METHOD, AND MONITORING PROGRAM

(71) Applicant: NIPPON TELEGRAPH AND TELEPHONE CORPORATION, Tokyo (JP)

(72) Inventors: Naotaka SHIBATA, Musashino-shi, Tokyo (JP); Hirotaka UJIKAWA, Musashino-shi, Tokyo (JP)

(73) Assignee: NIPPON TELEGRAPH AND TELEPHONE CORPORATION, Tokyo (JP)

(21) Appl. No.: 17/914,849

(22) PCT Filed: Mar. 30, 2020
(86) PCT No.: PCT/JP2020/014565

§ 371 Date: Sep. 27, 2022

(51) Int. Cl. H04W 24/08; H04W 76/10; H04W 40/12

(52) U.S. Cl. CPC H04W 24/08; H04W 76/10; H04W 40/12; H04W 80/06

(57) ABSTRACT

A monitoring device that monitors a network to which a plurality of terminal devices establishing a connection based on TCP are connected, includes: a request detection unit that detects a connection establishment request that a terminal device becoming a client sends to another terminal device becoming a server; an available bandwidth calculation unit that calculates an available bandwidth by subtracting a current amount of traffic from an allowable communication capacity, for each communication path identified by the connection establishment request detected by the request detection unit; and a setting command unit that, when the available bandwidth calculated by the available bandwidth calculation unit is smaller than a congestion window, transmits a command that sets the client to lower a slow start threshold to a predetermined value, or a command that sets the server to lower a window size to a predetermined value, regardless of whether or not a timeout occurs.

### TECHNICAL FIELD

The present invention relates to a monitoring device, a communication system, a communication control method, and a monitoring program.

### BACKGROUND ART

In some communication systems where communication is performed over a network, highly reliable communication is accomplished between a client and a server by establishing a connection, for example, based on TCP (Transmission Control Protocol).

Terminal devices used in such communication systems include, for example, mobile telephones, smartphones, PCs (personal computers), server devices, and the like. For the network, a PON (Passive Optical Network), a mobile communication system, a ring network, a mesh network, and the like can be cited.

### CITATION LIST

### Non-Patent Literature

Non-Patent Literature 1: Takafumi Takeshita, et al. “Mastering TCP/IP —Elementary Edition”, Fifth edition, Ohmsha, Ltd., Feb. 25, 2012, pp. 230-256

### SUMMARY OF THE INVENTION

### Technical Problem

In TCP communication, an algorithm called slow start is adopted when communication is started, in order to prevent a network capacity from being exceeded as a result of a client such as a terminal device sending a large amount of data to a server from the beginning.

Slow start has parameters such as congestion window (CW), slow start threshold (SST), and the like.

An amount of data sent by a terminal device depends on CW. A terminal device has an initial value of CW that is set low, and exponentially increase the value of CW upon receiving an acknowledgment (ACK) from a server.

SST is set at the same value as a maximum value of CW when communication is started. However, when a timeout occurs, SST is set to half the then CW. In addition, when a timeout occurs, CW is reset back to 1.

Thereafter, in an area where CW>SST, CW makes a linear increase, which is less sharp than an exponential increase, so that congestion is avoided.

Accordingly, when an available bandwidth of a network is small, CW is frequently reset back to 1, and throughput decreases.

An object of the present invention is to provide a monitoring device, a communication system, a communication control method, and a monitoring program that can enhance throughput of a terminal device when the terminal device establishes a connection based on TCP.

### Means for Solving the Problem

A monitoring device according to an aspect of the present invention is a monitoring device that monitors a network to which a plurality of terminal devices establishing a connection based on TCP are connected, the monitoring device including: a request detection unit that detects a connection establishment request that a terminal device becoming a client sends to another terminal device becoming a server; an available bandwidth calculation unit that calculates an available bandwidth by subtracting a current amount of traffic from an allowable communication capacity, for each communication path identified by the connection establishment request detected by the request detection unit; and a setting command unit that, when the available bandwidth calculated by the available bandwidth calculation unit is smaller than a congestion window, transmits a command that sets the client to lower a slow start threshold to a predetermined value, or a command that sets the server to lower a window size to a predetermined value, regardless of whether or not a timeout occurs.

A communication system according to an aspect of the present invention is a communication system including a plurality of terminal devices that establish a connection based on TCP, and a monitoring device that monitors communications of the plurality of terminal devices, the communication system including: a request detection unit that detects a connection establishment request that a terminal device becoming a client sends to another terminal device becoming a server; an available bandwidth calculation unit that calculates an available bandwidth by subtracting a current amount of traffic from an allowable communication capacity, for each communication path identified by the connection establishment request detected by the request detection unit; and a setting command unit that, when the available bandwidth calculated by the available bandwidth calculation unit is smaller than a congestion window, transmits a command that sets the client to lower a slow start threshold to a predetermined value, or a command that sets the server to lower a window size to a predetermined value, regardless of whether or not a timeout occurs.

A communication control method according to an aspect of the present invention is a communication control method for controlling communications of a plurality of terminal devices that establish a connection based on TCP, the communication control method including: a request detection step of detecting a connection establishment request that a terminal device becoming a client sends to another terminal device becoming a server; an available bandwidth calculation step of calculating an available bandwidth by subtracting a current amount of traffic from an allowable communication capacity, for each communication path identified by the detected connection establishment request; and a setting command step of, when the calculated available bandwidth is smaller than a congestion window, transmitting a command that sets the client to lower a slow start threshold to a predetermined value, or a command that sets the server to lower a window size to a predetermined value, regardless of whether or not a timeout occurs.

### Effects of the Invention

According to the present invention, throughput of a terminal device can be enhanced when the terminal device establishes a connection based on TCP.

### BRIEF DESCRIPTION OF DRAWINGS

FIG. 1 shows an example of a configuration of a communication system.

FIG. 2 is a graph showing changes over time in congestion window and slow start threshold in the communication system.

FIG. 3 shows an example of a configuration of a communication system according to an embodiment.

FIG. 4 is a functional block diagram showing an outline of functions included in a comprehensive monitoring device according to the embodiment.

FIG. 5 is a graph illustrating SST that a setting command unit sets on a client.

FIG. 6 shows an example of a configuration of a communication system according to an embodiment.

FIG. 7 is a functional block diagram showing an outline of functions included in a comprehensive monitoring device according to the embodiment.

FIG. 8 shows an example of a configuration of a communication system according to an embodiment.

FIG. 9 is a functional block diagram showing an outline of functions included in a comprehensive monitoring device according to the embodiment.

FIG. 10 shows an example of a hardware configuration of the comprehensive monitoring device, according to an embodiment.

### DESCRIPTION OF EMBODIMENTS

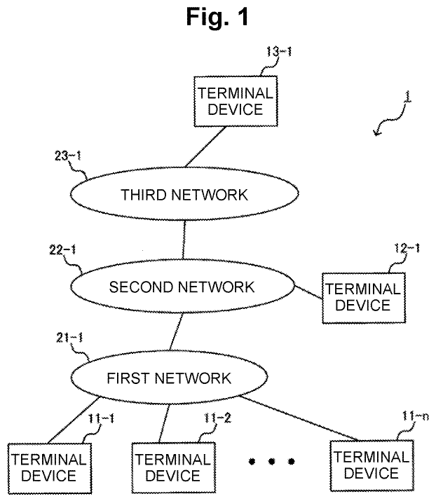

First, a description will be given of a background about how the present invention has been devised. FIG. 1 shows an example of a configuration of a communication system 1. As shown in FIG. 1, the communication system 1 includes, for example, a first network 21-1 to which terminal devices 11-1 to 11-n are connected, a second network 22-1 to which a terminal device 12-1 is connected, and a third network 23-1 to which a terminal device 13-1 is connected. In the communication system 1, the terminal devices 11-1 to 11-n, 12-1, and 13-1 can perform communication with each other by establishing a TCP connection.

Communication here may be any of wired communication and wireless communication. Note that when TCP communication is performed, it is assumed that any one of the terminal devices 11-1 to 11-n, 12-1, and 13-1 that first transmits a connection establishment request packet is a client, and that any one of the terminal devices 11-1 to 11-n, 12-1, and 13-1 that first receives the connection establishment request packet is a server.

As a more specific example of the configuration, the communication system 1 may be configured such that the terminal device 11-1 that is a mobile telephone performs TCP communication with the terminal device 13-1 that is a server (content server) installed in a data center and managing data (content).

In such a case, communication between the first network 21-1 and the terminal device 11-1 is, for example, wireless communication. The first network 21-1 is assumed to be a wireless network including a base station function and an antenna. The second network 22-1 is assumed to be, for example, a network in a predetermined area such as a prefecture, in a backhaul to the base station. The third network 23-1 is assumed to be a wide area network spanning prefectures or the like, in a backhaul to the base station. The third network 23-1 and the terminal device 13-1 perform communication, for example, through wired communication.

As another specific example of the configuration, the communication system 1 may be configured such that the terminal device 11-2 that is a PC performs TCP communication with the terminal device 12-1 that is also a PC.

Here, when the terminal device 11-2 performs P2P (Peer to Peer) communication with the terminal device 12-1, communication between the first network 21-1 and the terminal device 11-2 is, for example, wired communication. Moreover, the first network 21-1 is assumed to be a PON system in which FTTH (Fiber To The Home) is constructed. The second network 22-1 is also assumed to be a PON system in a different area from an area of the first network 21-1. The second network 22-1 and the terminal device 12-1 perform communication, for example, through wired communication.

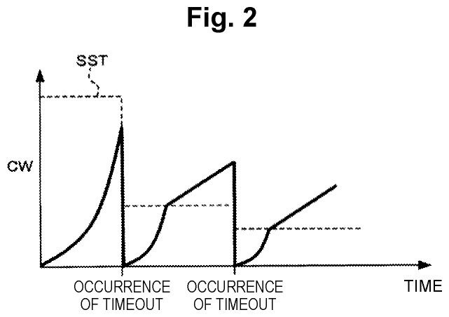

FIG. 2 is a graph showing changes over time in congestion window (CW) and slow start threshold (SST) in the communication system 1.

First, a client sets the size of CW to 1 MSS (Maximum Segment Size) when beginning slow start, and increases CW each time an acknowledgement (ACK) is received. A server notifies the client of a receivable window size according to a loaded state of the own device.

When sending a data packet, the client compares CW with the window size transmitted by the server, and sends the data packet in a size equal to or smaller than a lower one of the values of CW and the window size.

When a timeout occurs, the client resets CW to 1 and performs slow start again. Moreover, when the timeout occurs, the client sets the size of the slow start threshold to half the then window.

As described above, in TCP communication, throughput is gradually increased after communication is started, but when a network is congested, a timeout occurs and throughput suddenly decreases.

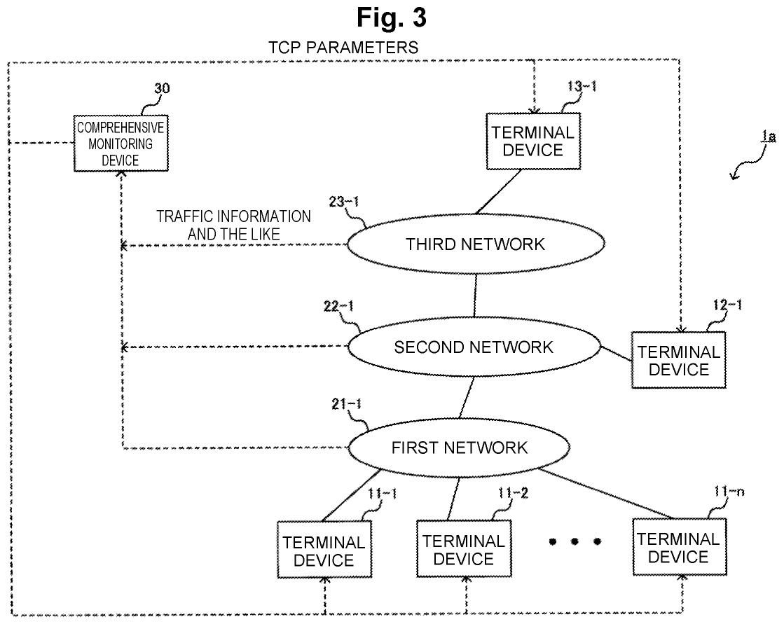

Next, a communication system according to an embodiment will be described. FIG. 3 shows an example of a configuration of a communication system 1a according to an embodiment.

As shown in FIG. 3, the communication system 1a includes, for example, a first network 21-1 to which terminal devices 11-1 to 11-n are connected, a second network 22-1 to which a terminal device 12-1 is connected, a third network 23-1 to which a terminal device 13-1 is connected, and a comprehensive monitoring device 30. In the communication system 1a, the terminal devices 11-1 to 11-n, 12-1, and 13-1 can perform communication with each other by establishing a TCP connection. Note that components that are substantially the same as the components of the communication system 1 shown in FIG. 1 are denoted by the same signs.

The comprehensive monitoring device 30 is a monitoring device that comprehensively monitors and controls network communications in the communication system 1a. For example, the comprehensive monitoring device 30 acquires traffic information on each path for communications performed by the terminal devices 11-1 to 11-n, 12-1, and 13-1, SYN packets for TCP connection establishment in the communication system 1a, and the like via the first network 21-1, the second network 22-1, and the third network 23-1, and transmits control parameters (TCP parameters) for TCP communication to the terminal devices 11-1 to 11-n, 12-1, and 13-1.

Note that a path (communication path) through which the comprehensive monitoring device 30 transmits the TCP parameters may be any path. For example, the comprehensive monitoring device 30 transmits the TCP parameters to the terminal devices 11-1 to 11-n, 12-1, and 13-1 via the first network 21-1, the second network 22-1, and the third network 23-1.

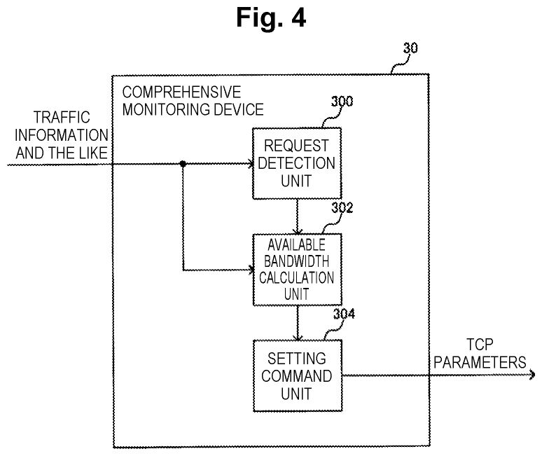

FIG. 4 is a functional block diagram showing an outline of functions included in the comprehensive monitoring device 30 according to the embodiment. The comprehensive monitoring device 30 includes, for example, a request detection unit 300, an available bandwidth calculation unit 302, and a setting command unit 304.

The request detection unit 300 detects a TCP connection establishment request (SYN packet: connection request) that a terminal device becoming a client sends to another terminal device becoming a server, and outputs information indicating that the client has sent the connection establishment request to the server, a source address, and a destination address to the available bandwidth calculation unit 302.

For each communication path identified by the connection establishment request detected by the request detection unit 300, the available bandwidth calculation unit 302 calculates an available bandwidth by subtracting a current amount of traffic from an allowable communication capacity.

For example, the available bandwidth calculation unit 302 stores a communication capacity of each network (each communication path) beforehand, measures a currently used bandwidth by using a network traffic amount measurement function included in the available bandwidth calculation unit 302, and calculates an available bandwidth by subtracting the amount of traffic from the communication capacity.

At the time, the available bandwidth calculation unit 302 narrows all networks in the communication system 1a down to networks to be followed by a communication for which the SYN packet is detected by the request detection unit 300, and calculates an available bandwidth by using traffic information indicating an amount of traffic and the like on each of the networks. The available bandwidth calculation unit 302 outputs, for example, the smallest value of the available bandwidths of the individual networks to the setting command unit 304.

Note that the available bandwidth calculation unit 302 may use an IP address or a MAC address in narrowing down to the networks to be followed by the communication for which the SYN packet is detected. In other words, the available bandwidth calculation unit 302 may store an IP address or a MAC address on a network through which data has passed, and may identify under which network the stored IP address or MAC address exists. When networks (communication paths) cannot be narrowed down, the available bandwidth calculation unit 302 may calculate the available bandwidth on the assumption that data follows all communication paths.

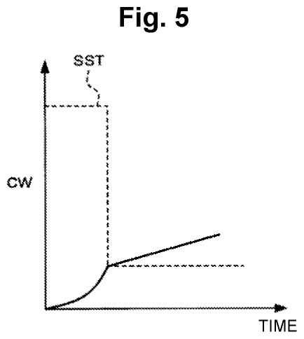

When the available bandwidth calculated by the available bandwidth calculation unit 302 is smaller than CW (for example, a first SST), the setting command unit 304 transmits a command that sets the client to lower SST to a predetermined value, regardless of whether or not a timeout occurs. FIG. 5 is a graph illustrating SST that the setting command unit 304 sets on a client.

When the available bandwidth calculated by the available bandwidth calculation unit 302 is smaller than CW (for example, the first SST), the setting command unit 304 may transmit a command that sets the server to lower the window size to a predetermined value.

As a specific example, the setting command unit 304 may transmit a command that sets the client to lower SST to a minimum value, a command that sets, on the client, a value of SST that varies according to a plurality of predetermined values of CW (first to n-th predetermined thresholds), or a command that sets, on the server, a value of the window size that varies according to the plurality of predetermined values of CW (first to n-th predetermined thresholds).

In the comprehensive monitoring device 30, when the request detection unit 300 detects a plurality of communications (SYN packets) at the same time, the setting command unit 304 may transmit commands that set the clients or the servers, based on a total amount of traffic of the plurality of communications, and an available bandwidth of each communication path.

Further, when the plurality of communications include communications with different degrees of priority or different degrees of importance of services or the like, the setting command unit 304 may be configured to transmit a command that makes a setting to lower SST or the window size in ascending order from a communication with the lowest degree of priority or the lowest degree of importance.

For example, the comprehensive monitoring device 30 restricts the amount of traffic by lowering SST or the window size in ascending order from a communication with the lowest degree of priority or the lowest degree of importance, and when the secured available bandwidth becomes a sufficient amount thereafter, the processing of lowering SST or the window size for communications with lower degrees of priority or lower degrees of importance may be stopped.

Then, the client compares a bandwidth based on the own CW and SST with a bandwidth indicated by the window size, and sends an amount of data adapted to the smaller bandwidth to the server.

Note that each of the client and the server is assumed to include a function of changing SST or the window size, according to the TCP parameters transmitted from the comprehensive monitoring device 30.

As described above, the communication system 1a can avoid congestion by restricting throughput of traffic with a lower degree of priority or a lower degree of importance, without causing a decrease in throughput of traffic with a higher degree of priority or a higher degree of importance.

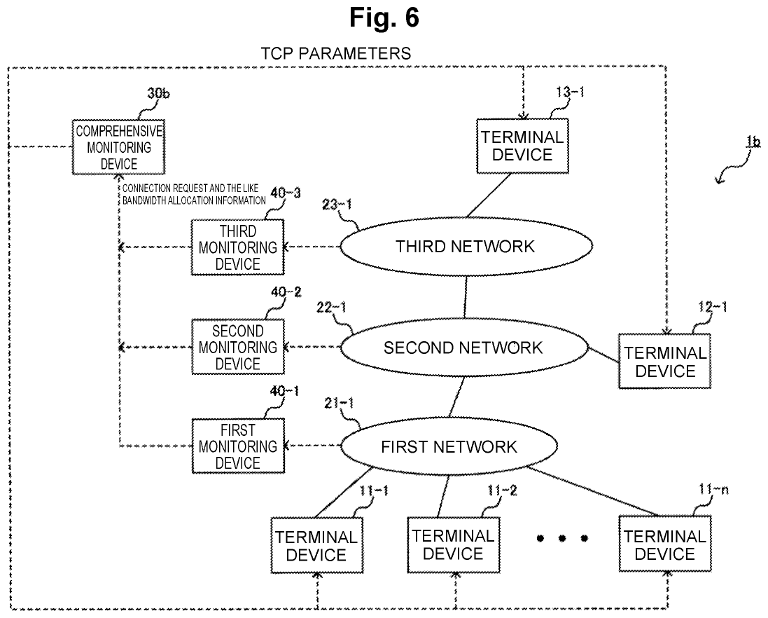

Next, a first modification example (communication system 1b) of the communication system 1a, according to an embodiment will be described. FIG. 6 shows an example of a configuration of the communication system 1b according to the embodiment.

As shown in FIG. 6, the communication system 1b includes, for example, a first network 21-1 to which terminal devices 11-1 to 11-n are connected, a second network 22-1 to which a terminal device 12-1 is connected, a third network 23-1 to which a terminal device 13-1 is connected, a comprehensive monitoring device 30b, and a first monitoring device 40-1 to a third monitoring device 40-3. In the communication system 1b, the terminal devices 11-1 to 11-n, 12-1, and 13-1 can perform communication with each other by establishing a TCP connection. Note that components that are substantially the same as the components of the communication system 1 shown in FIG. 1 are denoted by the same signs.

The first monitoring device 40-1 is a monitoring device that monitors and controls network communications in the first network 21-1. For example, the first monitoring device 40-1 acquires traffic information on each path for communications performed by the terminal devices 11-1 to 11-n over the first network 21-1, SYN packets (connection requests) for TCP connection establishment, and the like, and outputs the acquired connection requests and respective bandwidth allocation information on the communications in the first network 21-1, to the comprehensive monitoring device 30b.

Specifically, the first monitoring device 40-1 detects a connection request in the first network 21-1, and transmits information indicating that a client has sent a connection establishment request to a server, a source address, a destination address, and bandwidth allocation information to the comprehensive monitoring device 30b.

The second monitoring device 40-2 is a monitoring device that monitors and controls network communications in the second network 22-1. For example, the second monitoring device 40-2 acquires traffic information on each path for a communication performed by the terminal device 12-1 over the second network 22-1, a SYN packet (connection request) for TCP connection establishment, and the like, and outputs the acquired connection request and respective bandwidth allocation information on the communication in the second network 22-1, to the comprehensive monitoring device 30b.

Specifically, the second monitoring device 40-2 detects a connection request in the second network 22-1, and transmits information indicating that a client has sent a connection establishment request to a server, a source address, a destination address, and bandwidth allocation information to the comprehensive monitoring device 30b.

The third monitoring device 40-3 is a monitoring device that monitors and controls network communications in the third network 23-1. For example, the third monitoring device 40-3 acquires traffic information on each path for a communication performed by the terminal device 13-1 over the third network 23-1, a SYN packet (connection request) for TCP connection establishment, and the like, and outputs the acquired connection request and respective bandwidth allocation information on the communication in the third network 23-1, to the comprehensive monitoring device 30b.

Specifically, the third monitoring device 40-3 detects a connection request in the third network 23-1, and transmits information indicating that a client has sent a connection establishment request to a server, a source address, a destination address, and bandwidth allocation information to the comprehensive monitoring device 30b.

The comprehensive monitoring device 30b is a monitoring device that comprehensively monitors and controls network communications in the communication system 1b. For example, the comprehensive monitoring device 30b acquires the traffic information on each path for the communications performed by the terminal devices 11-1 to 11-n, 12-1, and 13-1, the SYN packets (connection requests) for TCP connection establishment in the communication system 1b, the respective bandwidth allocation information, and the like via the first monitoring device 40-1 to third monitoring device 40-3, and transmits the control parameters (TCP parameters) for TCP communication to the terminal devices 11-1 to 11-n, 12-1, and 13-1.

Note that a path (communication path) through which the comprehensive monitoring device 30b transmits the TCP parameters may be any path. For example, the comprehensive monitoring device 30b may transmit the TCP parameters to the terminal devices 11-1 to 11-n, 12-1, and 13-1 via the first monitoring device 40-1 to third monitoring device 40-3.

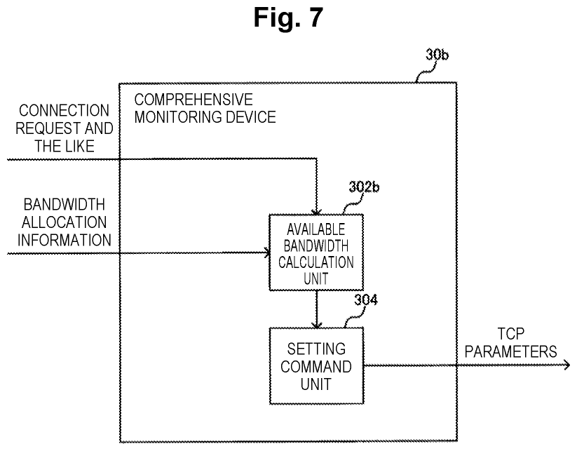

FIG. 7 is a functional block diagram showing an outline of functions included in the comprehensive monitoring device 30b according to the embodiment. The comprehensive monitoring device 30b includes, for example, an available bandwidth calculation unit 302b and a setting command unit 304.

The available bandwidth calculation unit 302b calculates an available bandwidth based on the bandwidth allocation information inputted from the first monitoring device 40-1 to third monitoring device 40-3, for each communication path identified by the connection requests inputted from the first monitoring device 40-1 to third monitoring device 40-3, and outputs the available bandwidth to the setting command unit 304. For example, the available bandwidth calculation unit 302b calculates an available bandwidth by subtracting an amount of traffic based on the current bandwidth allocation information from a communication capacity allowable for each communication path.

When a connection request is detected in a plurality of networks, the available bandwidth calculation unit 302b, for example, collects communication paths with coinciding source addresses and destination addresses, and, for each set of the collected communication paths, outputs the smallest value of the available bandwidths to the setting command unit 304.

When the available bandwidth calculated by the available bandwidth calculation unit 302b is smaller than CW (for example, a first SST), the setting command unit 304 transmits a command that sets the client to lower SST to a predetermined value, regardless of whether or not a timeout occurs.

In other words, a processing load on the comprehensive monitoring device 30b is lighter than a processing load on the above-described comprehensive monitoring device 30.

Note that each of the client and the server is assumed to include a function of changing SST or the window size, according to the TCP parameters transmitted from the comprehensive monitoring device 30b.

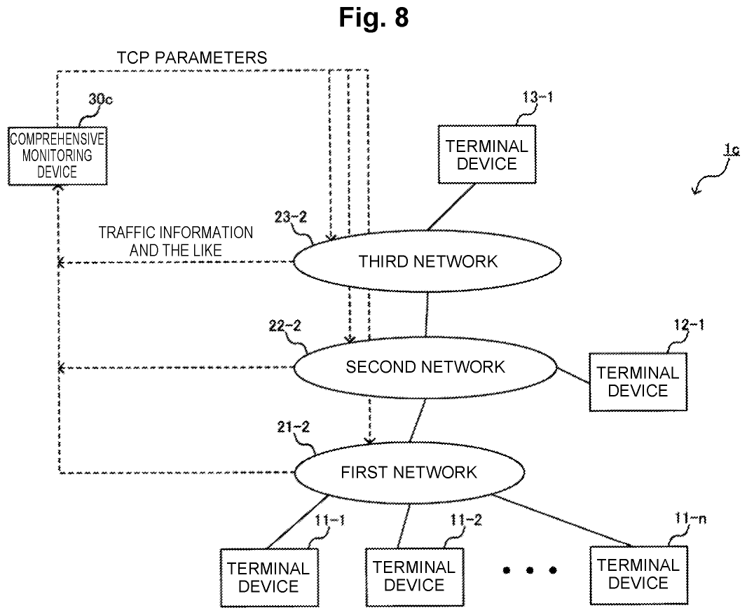

Next, a second modification example (communication system 1c) of the communication system 1a, according to an embodiment will be described. FIG. 8 shows an example of a configuration of the communication system 1c according to the embodiment.

As shown in FIG. 8, the communication system 1c includes, for example, a first network 21-2 to which terminal devices 11-1 to 11-n are connected, a second network 22-2 to which a terminal device 12-1 is connected, a third network 23-2 to which a terminal device 13-1 is connected, and a comprehensive monitoring device 30c. In the communication system 1c, the terminal devices 11-1 to 11-n, 12-1, and 13-1 can perform communication with each other by establishing a TCP connection. Note that components that are substantially the same as the components of the communication system 1 shown in FIG. 1 are denoted by the same signs.

The comprehensive monitoring device 30c is a monitoring device that comprehensively monitors and controls network communications in the communication system 1c. For example, the comprehensive monitoring device 30c acquires traffic information on each path for communications performed by the terminal devices 11-1 to 11-n, 12-1, and 13-1, SYN packets for TCP connection establishment in the communication system 1c, and the like via the first network 21-2, the second network 22-2, and the third network 23-2.

Then, the comprehensive monitoring device 30c transmits the control parameters (TCP parameters) for TCP communication, not to the terminal devices 11-1 to 11-n, 12-1, and 13-1b, but to the first network 21-2, the second network 22-2, and the third network 23-2.

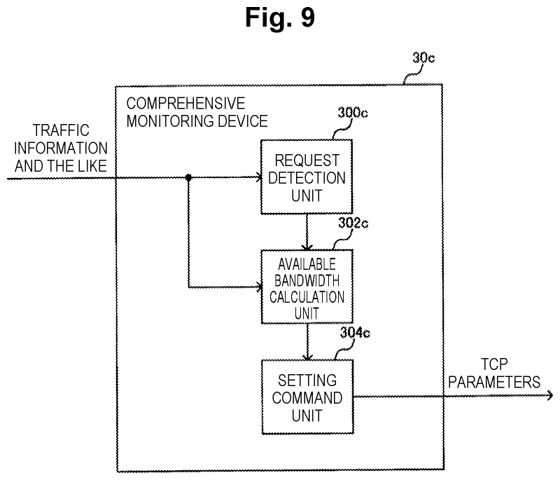

FIG. 9 is a functional block diagram showing an outline of functions included in the comprehensive monitoring device 30c according to the embodiment. The comprehensive monitoring device 30c includes, for example, a request detection unit 300c, an available bandwidth calculation unit 302c, and a setting command unit 304c.

The request detection unit 300c detects a TCP connection establishment request (SYN packet: connection request) that a terminal device becoming a client sends to another terminal device becoming a server, and outputs information indicating that the client has sent the connection establishment request to the server, a source address, and a destination address to the available bandwidth calculation unit 302c.

For each communication path identified by the connection establishment request detected by the request detection unit 300c, the available bandwidth calculation unit 302c calculates an available bandwidth by subtracting a current amount of traffic from an allowable communication capacity.

When the available bandwidth calculated by the available bandwidth calculation unit 302c is smaller than CW (for example, a first SST), the setting command unit 304c transmits a command that makes a setting to lower SST to a predetermined value, regardless of whether or not a timeout occurs.

When the available bandwidth calculated by the available bandwidth calculation unit 302c is smaller than CW (for example, the first SST), the setting command unit 304c may transmit a command that makes a setting to lower the window size to a predetermined value.

In each of the first network 21-2, the second network 22-2, and the third network 23-2, the TCP parameter with respect to the client or the server is rewritten, based on the source address and the destination address of the communication path for which the connection establishment request is detected, among signals flowing from the own network to terminal devices or another network.

Note that the communication path for which the connection establishment request is detected may be identified by any information as long as the information can uniquely identify the communication path, such as an IP address, a MAC address, or a VID (VLAN Identifier).

For example, in the first network 21-2, the second network 22-2, and the third network 23-2, the window size notified from the server is rewritten according to the available bandwidth. At the time, the TCP parameter may be rewritten at any arbitrary port in the network.

As described hereinabove, when an available bandwidth is smaller than CW, the communication systems 1a, 1b, and 1c transmit a command that sets the client to lower SST to a predetermined value, or a command that sets the server to lower the window size to a predetermined value, while CW is made larger than 1 MSS. Accordingly, when a terminal device establishes a connection based on TCP, throughput of the terminal device can be enhanced.

Note that one or some, or all, of the functions included in the terminal devices 11-1 to 11-n, 12-1, and 13-1, the comprehensive monitoring devices 30, 30b, 30c, and the first monitoring device 40-1 to third monitoring device 40-3 may be configured by using hardware, or may be configured as a program to be executed by a processor such as a CPU.

In other words, the communication system 1 according to the present invention can be implemented by using a computer and a program, and the program can be recorded on a storage medium or can be provided through a network.

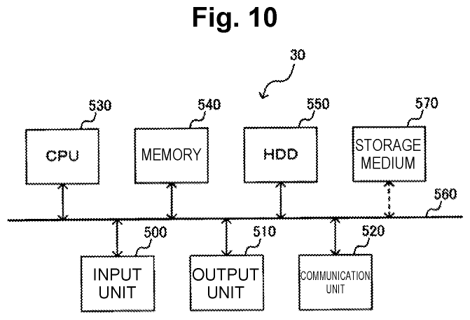

FIG. 10 shows an example of a hardware configuration of the comprehensive monitoring device 30, according to an embodiment. As shown in FIG. 10, in the comprehensive monitoring device 30, for example, an input unit 500, an output unit 510, a communication unit 520, a CPU 530, a memory 540, and an HDD 550 are connected through a bus 560, and the comprehensive monitoring device 30 has functions as a computer. The comprehensive monitoring device 30 is configured to be able to receive data as input from and output data to a storage medium 570.

The input unit 500 includes, for example, a keyboard, a mouse, and the like. The output unit 510 is, for example, a display device such as a display. The communication unit 520 is, for example, a wireless or wired network interface.

The CPU 530 controls each unit included in the comprehensive monitoring device 30 and performs the above-described processing. The memory 540 and the HDD 550 store data. The storage medium 570 is configured to be able to store a monitoring program that causes the functions included in the comprehensive monitoring device 30 to be executed, and the like. An architecture that configures the comprehensive monitoring device 30 is not limited to the example shown in FIG. 10. The comprehensive monitoring device 30b and the comprehensive monitoring device 30c may include components similar to the components of the comprehensive monitoring device 30.

### REFERENCE SIGNS LIST

1, 1a, 1b, 1c Communication system
11-1 to 11-n, 12-1, 13-1 Terminal device
21-1, 21-2 First network
22-1, 22-2 Second network
23-1, 23-2 Third network
30, 30b, 30c Comprehensive monitoring device
40-1 First monitoring device
40-2 Second monitoring device
40-3 Third monitoring device
300, 300c Request detection unit
302, 302b, 302c Available bandwidth calculation unit
304, 304c Setting command unit
500 Input unit
510 Output unit
520 Communication unit
530 CPU
540 Memory
550 HDD
560 Bus
570 Storage medium

1. A monitoring device that monitors a network to which a plurality of terminal devices establishing a connection based on TCP are connected, the monitoring device comprising:
a processor; and
a storage medium having computer program instructions stored thereon, when executed by the processor, perform to:
detects a connection establishment request that a terminal device becoming a client sends to another terminal device becoming a server;
calculates an available bandwidth by subtracting a current amount of traffic from an allowable communication capacity, for each communication path identified by the connection establishment request; and
when the available bandwidth is smaller than a congestion window, transmits a command that sets the client to lower a slow start threshold to a predetermined value, or a command that sets the server to lower a window size to a predetermined value, regardless of whether or not a timeout occurs.

2. The monitoring device according to claim 1, wherein the computer program instructions further perform to transmits a command that sets the client to lower the slow start threshold to a minimum value, a command that sets, on the client, a value of the slow start threshold that varies according to a plurality of predetermined values of the congestion window, or a command that sets, on the server, a value of the window size that varies according to the plurality of predetermined values of the congestion window.

3. The monitoring device according to claim 1, wherein the computer program instructions further perform to transmits a command that makes a setting to lower the slow start threshold or the window size in ascending order from a communication with a lowest degree of priority or a lowest degree of importance.

4. A communication system including a plurality of terminal devices that establish a connection based on TCP, and a monitoring device that monitors communications of the plurality of terminal devices, the communication system comprising:
a request detection unit that detects a connection establishment request that a terminal device becoming a client sends to another terminal device becoming a server;
an available bandwidth calculation unit that calculates an available bandwidth by subtracting a current amount of traffic from an allowable communication capacity, for each communication path identified by the connection establishment request detected by the request detection unit; and
a setting command unit that, when the available bandwidth calculated by the available bandwidth calculation unit is smaller than a congestion window, transmits a command that sets the client to lower a slow start threshold to a predetermined value, or a command that sets the server to lower a window size to a predetermined value, regardless of whether or not a timeout occurs.

5. The communication system according to claim 4, wherein the setting command unit transmits a command that sets the client to lower the slow start threshold to a minimum value, a command that sets, on the client, a value of the slow start threshold that varies according to a plurality of predetermined values of the congestion window, or a command that sets, on the server, a value of the window size that varies according to the plurality of predetermined values of the congestion window.

6. The communication system according to claim 4, wherein the setting command unit transmits a command that makes a setting to lower the slow start threshold or the window size in ascending order from a communication with a lowest degree of priority or a lowest degree of importance.

7. A communication control method for controlling communications of a plurality of terminal devices that establish a connection based on TCP, the communication control method comprising:
a request detection step of detecting a connection establishment request that a terminal device becoming a client sends to another terminal device becoming a server;
an available bandwidth calculation step of calculating an available bandwidth by subtracting a current amount of traffic from an allowable communication capacity, for each communication path identified by the detected connection establishment request; and
a setting command step of, when the calculated available bandwidth is smaller than a congestion window, transmitting a command that sets the client to lower a slow start threshold to a predetermined value, or a command that sets the server to lower a window size to a predetermined value, regardless of whether or not a timeout occurs.

8. (cancel)
